(19) United States
(12) Patent Application Publication
(10) Pub. No.: US 2012/0098852 A1
(43) Pub. Date: Apr. 26, 2012

(54) IMAGE DISPLAY DEVICE

(75) Inventors: Hidenori KURIBAYASHI, Tokyo (JP); Seiji TAKANO, Yokohama-shi (JP)

(73) Assignee: NIKON CORPORATION, TOKYO (JP)

(21) Appl. No.: 13/251,760

(22) Filed: Oct. 3, 2011

(30) Foreign Application Priority Data
Oct. 7, 2010 (JP) 2010-227151
Sep. 14, 2011 (JP) 2011-200830

(51) Int. Cl. G09G 5/02; G09G 5/00

(52) U.S. Cl. 345/592; 345/625

(57) ABSTRACT

Provided are: an image display unit that displays an image based on image data; a detection unit that detects a position corresponding to the tip of an indication member that indicates a part of the image that has been displayed by the image display unit; an extraction unit that extracts image data for a predetermined region including the position corresponding to the tip from the image data; and a control unit that controls such that a window that displays an image that is based on the extracted image data extracted by the extraction unit is displayed on the image display unit.

### CROSS-REFERENCE TO RELATED APPLICATIONS

The disclosure of the following priority applications is herein incorporated by reference:

Japanese Patent Application No. 2010-227151 filed on Oct. 7, 2010; and Japanese Patent Application No. 2011-200830 filed on Sep. 14, 2011.

### TECHNICAL FIELD

The present invention relates to an image display device,

### BACKGROUND ART

A known projection device projects operation icons onto a projection surface (for example, see Patent Literature 1). According to this projection device, an operation can be performed by touching a finger to an operation icon projected onto the projection surface.

### CITATION LIST

### {Patent Literature}

Patent Literature 1: Japanese Unexamined Patent Application Publication No. 2009-064109

### SUMMARY OF INVENTION

### Technical Problem

However, in the above-described projection device, the operation icon is shaded by a hand when the hand is held over the projection screen, and it is sometimes unclear where a fingertip has been pointed.

It is an object of the present invention to provide an image display device in which the image at a place that has been pointed to can be clarified.

### Solution to Problem

The image display device of the present invention includes: an image display unit that displays an image based on image data; a detection unit that detects a position corresponding to the tip of an indication member that indicates a part of the image that has been displayed by the image display unit; an extraction unit that extracts image data for a predetermined region including the position corresponding to the tip from the image data; and a control unit that controls such that a window that displays an image that is based on the extracted image data extracted by the extraction unit is displayed on the image display unit.

### Advantageous Effects of Invention

According to the image display device of the present invention, the image at a place that has been pointed to can be clarified.

### BRIEF DESCRIPTION OF DRAWINGS

FIG. 1 is a perspective view depicting a projected state and a photographed state of a projector according to a first embodiment;

FIG. 2 is a block diagram depicting the configuration of the projector according to the first embodiment;

FIG. 3 is a flowchart depicting a process in the projector according to the first embodiment;

FIG. 4 is a diagram depicting an extraction region on a projected image that has been projected by the projector according to the first embodiment;

FIG. 5 is a diagram depicting an extraction region on a projected image that has been projected by the projector according to the first embodiment;

FIG. 6 is a diagram depicting a window superimposed and projected onto a projected image by the projector according to the first embodiment;

FIG. 7 is a diagram depicting a window superimposed and projected onto a projected image by the projector according to the first embodiment;

FIG. 8 is a diagram depicting a pointer superimposed and projected into a window by the projector according to the first embodiment;

FIG. 9 is a diagram depicting a transparent window projected by the projector according to the first embodiment;

FIG. 10 is a diagram depicting a transparent window projected by the projector according to the first embodiment;

FIG. 11 is a diagram depicting a window superimposed and projected onto a projected image by the projector according to the first embodiment;

FIG. 12 is a diagram depicting the approach direction of a fingertip relative to a region of a projected image projected by the projector according to the first embodiment;

FIG. 13 is a diagram depicting a window superimposed and projected onto a projected image by the projector according to the first embodiment;

FIG. 14 is a diagram depicting a window projected onto a region different from a projected image by the projector according to the first embodiment;

FIG. 15 is a diagram depicting an operational state of a tablet terminal according to a second embodiment;

FIG. 16 is a block diagram depicting the configuration of the tablet terminal according to the second embodiment;

FIG. 17 is a flowchart depicting a process in the tablet terminal according to the second embodiment;

FIG. 18 is a diagram depicting an estimated interruption region in the tablet terminal according to the second embodiment;

FIG. 19 is a diagram depicting an estimated interruption region in the tablet terminal according to the second embodiment;

FIG. 20 is a diagram depicting a window displayed on a display unit of the tablet terminal according to the second embodiment;

FIG. 21 is a diagram depicting a window displayed on the display unit of the tablet terminal according to the second embodiment;

FIG. 22 is a diagram depicting a window displayed on the display unit of the tablet terminal according to the second embodiment;

FIG. 23 is a diagram depicting a window displayed on the display unit of the tablet terminal according to the second embodiment;

FIG. 24 is a diagram depicting a window displayed on the display unit of the tablet terminal according to the second embodiment;

FIG. 25 is a diagram depicting an operational state of a tablet terminal according to a third embodiment;

FIG. 26 is a flowchart depicting the process in the tablet terminal according to the third embodiment;

FIG. 27 is a diagram depicting an estimated interruption region in the tablet terminal according to the third embodiment;

FIG. 28 is a diagram depicting an operational state of a tablet terminal according to a fourth embodiment;

FIG. 29 is a block diagram depicting the configuration of the tablet terminal according to the fourth embodiment;

FIG. 30 is a flowchart depicting a process in the tablet terminal according to the fourth embodiment;

FIG. 31 is a diagram depicting an image displayed on a display unit of the tablet terminal according to the fourth embodiment;

FIG. 32 is a diagram depicting a small terminal according to a fifth embodiment;

FIG. 33 is a block diagram depicting the configuration of the small terminal according to the fifth embodiment;

FIG. 34 is a flowchart depicting a process in the small terminal according to the fifth embodiment;

FIG. 35 is a diagram depicting a state in which the small terminal according to the fifth embodiment is retained vertically;

FIG. 36 is a diagram depicting a state in which the small terminal according to the fifth embodiment is retained horizontally;

FIG. 37 is a diagram depicting a state in which a holding hand is in contact with a display unit in a tablet terminal according to an embodiment;

FIG. 38 is a diagram depicting a state in which a holding hand is in contact with a frame portion in a tablet terminal according to an embodiment;

FIG. 39 is a diagram depicting a state in which a tablet terminal according to an embodiment is retained, with the right hand serving as a holding hand, and inclined downward to the left;

FIG. 40 is a diagram depicting a photography range in a tablet terminal according to an embodiment;

FIG. 41 is a diagram depicting an operational state of a tablet terminal according to an embodiment; and

FIG. 42 is a diagram depicting an operational state of a tablet terminal according to an embodiment.

### DESCRIPTION OF EMBODIMENTS

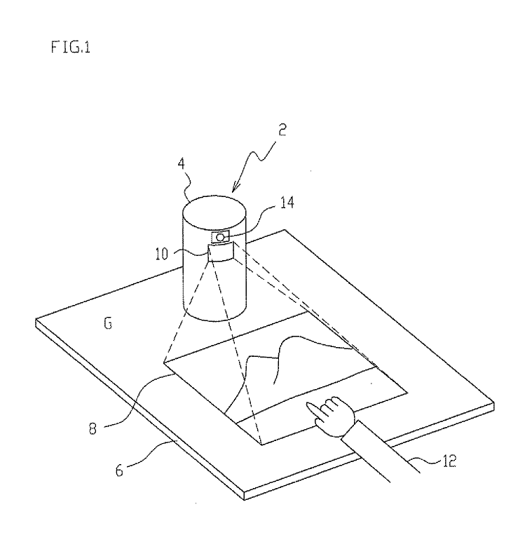

The following takes an example of a projector to describe an image display device according to a first embodiment, with reference to the drawings. FIG. 1 is a perspective view depicting a projected state and a photographed state of a projector 2 according to the first embodiment. The projector 2 is provided with a casing 4 made of metal or plastic, the casing 4 being mounted onto a mounting surface G, which is the top surface of a desk 6 or the like. The front surface of the casing 4 is provided with a projection window 10 that projects a projected image 8 onto the mounting surface G, and with a photography window 14 that photographs an indication member of a hand 12 or the like indicating a part of the projected image 8.

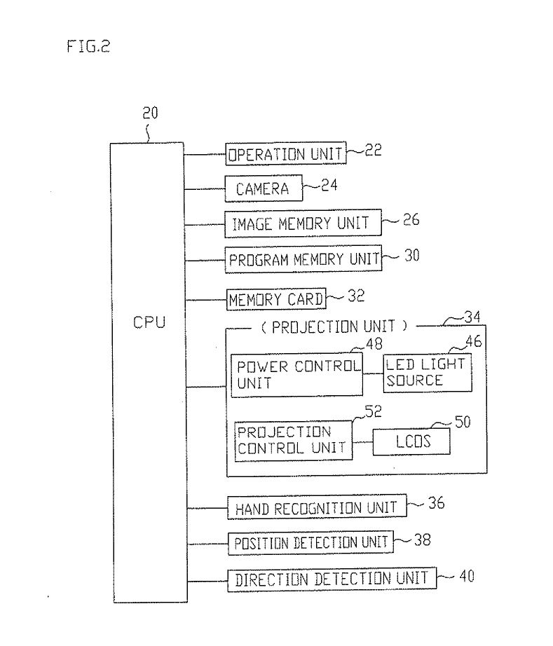

FIG. 2 is a block diagram depicting the system configuration of the projector 2 according to the first embodiment. The projector 2 is provided with a CPU 20, the CPU 20 being connected to an operation unit 22 provided with a power switch and the like (not shown); a camera 24 having an imaging sensor constituted of a CCD or the like that photographs a subject; an image memory unit 26 that stores image data of an image photographed by the camera 24; a program memory unit 30 that houses a program for setting and controlling related to photography, projection, and the like; a memory card 32 that stores image data of an image to be projected; a projection unit 34 that projects an image that is based on the image data stored in the image memory unit 26 and the memory card 32; a hand recognition unit 36 that determines whether or not the shape of a hand 12 is contained in the photographed image; a position detection unit 38 that detects a position on the projected image 8 directly under the fingertip and a region on the projected image 8 shaded by the hand 12; and a direction detection unit 40 that detects a direction indicated by the hand 12 from the shape of the hand 12 determined in the hand recognition unit 36. Herein, the projection unit 34 is provided with a power control unit 48 that turns an LED light source 46 on and off, and a projection control unit 52 that controls the display of an LCOS 50 that displays an image to be projected.

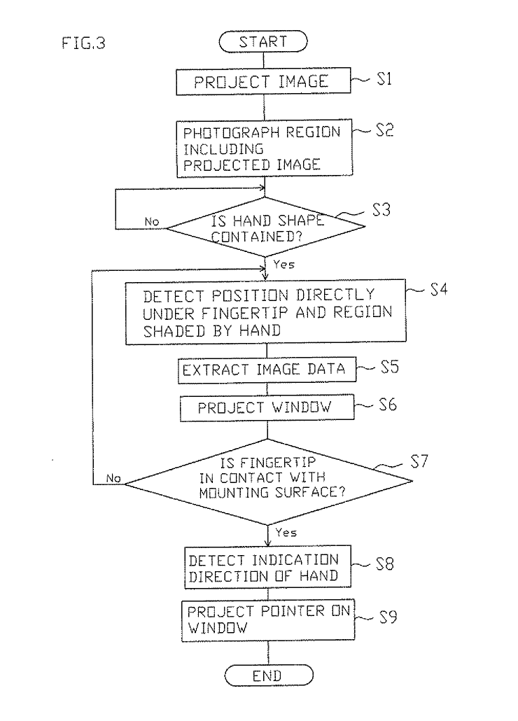

The following is a description of a process in the projector according to the first embodiment, with reference to the flowchart depicted in FIG. 3. First, the casing 4 is mounted onto a mounting surface G, and when the power is switched on, the CPU 20 indicates to the projection unit 34 to begin projecting, and reads out image data from the memory card 32 in order to use the projection control unit 52 to display on the LCOS 50 an image that is based on the image data. The power control unit 48 also switches on the LED light source 46 by the indication to begin projecting, and, as depicted in FIG. 1, emits projection light in a downward-sloping direction from the projection window 10 so as to project the projected image 8 onto the mounting surface G (step S1).

The CPU 20 also uses the camera 24 to begin photographing a region that includes the projected image 8 (step S2). Herein, the camera 24 photographs using video photography or still image photography at fixed time intervals, and image data of the image photographed by the camera 24 is stored in the image memory unit 26.

Next, the CPU 20 reads out image data from the image memory unit 26 and uses the hand recognition unit 36 to determine whether or not the image data contains the shape of the hand 12 (step S3). Herein, whether or not the shape of the hand 12 is contained is determined to detect the region of the hand 12 and the position of the fingertips from the image data by using pattern matching or the like.

The CPU 20 repeats the operation of step S3 when the shape of the hand 12 is not contained in the image data (step S3: No). On the other hand, when the shape of the hand 12 is contained in the image data (step S3: Yes), the CPU 20 uses the position detection unit 38 to detect the position on the projected image 8 directly under the fingertip as well as the region on the projected image 8 shaded by the hand 12 (step S4).

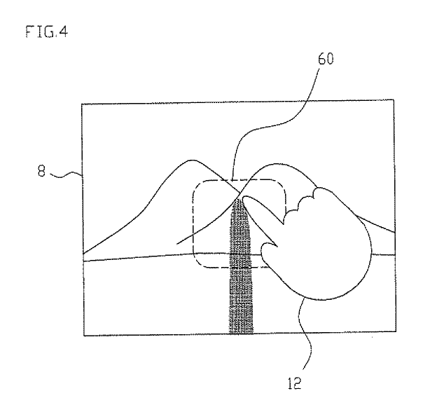

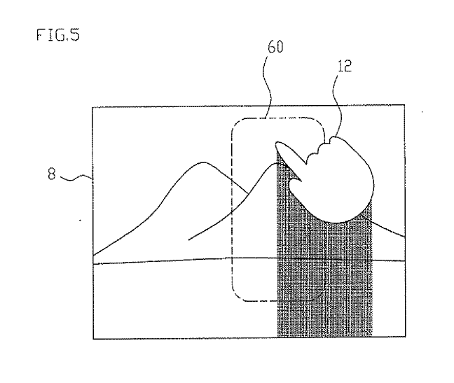

Next, as shown in FIG. 4, the CPU 20 extracts image data on a predetermined region 60 with respect to the position directly under the fingertip from the image data of the projected image 8, and stores the extracted image data in the image memory unit 26 (step S5). Herein, the range of the predetermined region 60 is determined in accordance with the area shaded by the hand 12. For this reason, the CPU 20 extracts image data for a region 60 with a narrow range (see FIG. 4) when the area shaded by the hand 12 is small, and extracts image data for a region 60 with a broad range (see FIG. 5) when the area shaded by the hand 12 is large.

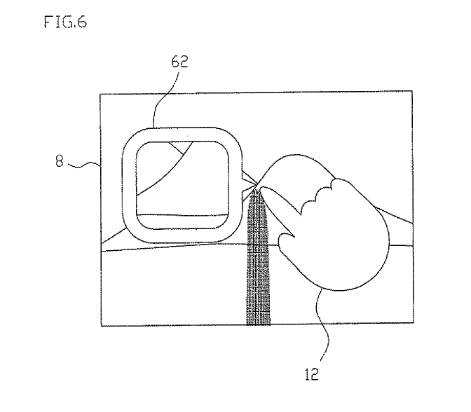

Next, the CPU 20 reads out the image data extracted from the image memory unit 26 and indicates the same to the projection unit 34 to project a window displaying an image that is based on the extracted image data onto a region in which the opposite side from the side where the hand 12 is found is not shaded by the hand 12 (step S6). For example, as shown in FIG. 6, the window 62 is projected onto a region positioned directly under the fingertip, of the left side of which is not shaded by the hand 12, when the hand 12 is found at the position depicted in FIG. 4.

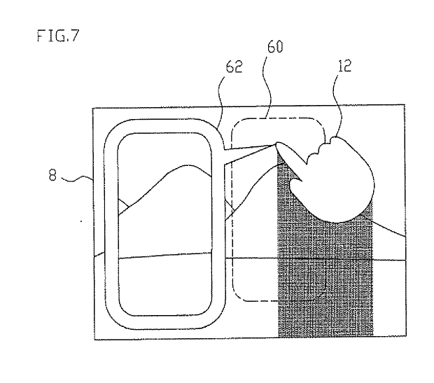

Herein, the size of the window 62 is determined in accordance with the size of the region 60 where the image data is extracted. For this reason, the projection unit 34 projects a small-sized window 62 (see FIG. 6) when the region 60 where the image data is extracted is narrow, and projects a large-sized window 62 (see FIG. 7) when the region 60 where the image data is extracted is wide.

Note that the position directly under the fingertip is detected sequentially, because the camera 24 photographs using video photography or the like. Further, a window 62 that displays the image of the predetermined region 60 with respect to the position directly under the fingertip is projected sequentially by the projection unit 34. For this reason, when the position of the hand 12 moves on the projected image 8, the projection region of the window 62 also moves following the position of the hand 12.

Next, the CPU 20 determines whether or not the fingertip is in contact with the mounting surface G from the image data (step 87). When the fingertip is not in contact with the mounting surface G (step S7: No), the CPU 20 repeats the operation of steps 84 to S6. On the other hand, when the fingertip is in contact with the mounting surface G (step S7: Yes), the CPU 20 uses the direction detection unit 40 to detect the indication direction of the hand 12 from the shape of the hand 12 as determined in the hand recognition unit 36 (step S8).

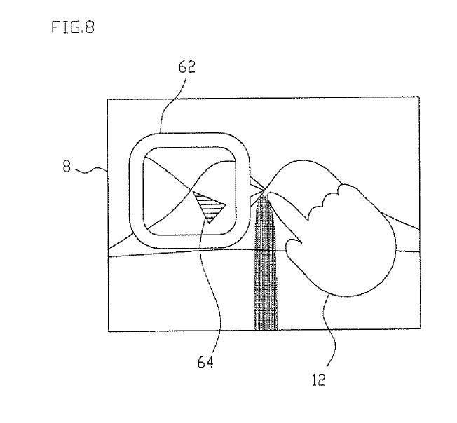

When the indication direction of the hand 12 is detected, the CPU 20 indicates to the projection unit 34, and superimposes and projects a pointer 64 corresponding to the indication direction of the hand 12 into the window 62, as depicted in FIG. 8 (step S9).

According to the projector 2 based on this first embodiment, the image at a place that has been pointed to with the hand 12 can be clarified by the superposition and projection onto the projected image 8 of the window 62 that displays the image contained in the predetermined region 60 with respect to the position directly under the fingertip. Also, the position on the projected image 8 that has been pointed to with the hand 12 can be further clarified by the superposition and projection of the pointer 64 that shows the indication direction of the hand 12 in the window 62.

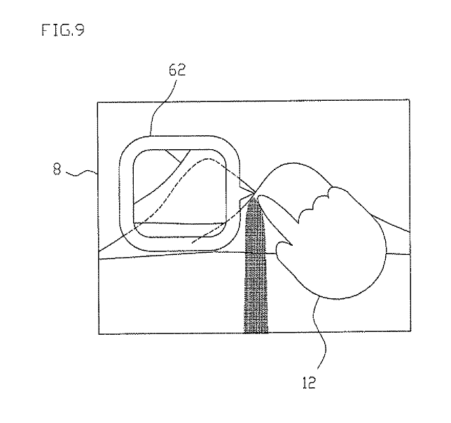

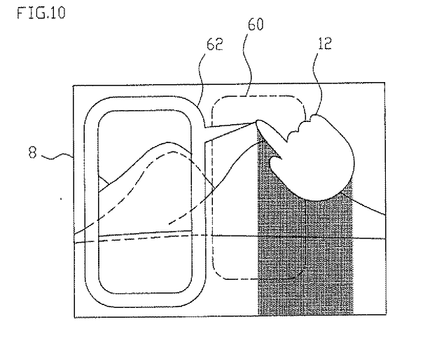

Note that in the projector 2 according to the above-described first embodiment, only the image that is based on the extracted image data is displayed in the window 62, but the window may be made to be transparent. In such a case, the transparency may be modified in conjunction with the size of the window 62. An operator can thereby recognize the image at the portion hidden under the window 62 even though the window 62 has been superimposed and projected onto the projected image 8. Further, as depicted in FIG. 9, the window 62 may be set to be less transparent when a small-sized window 62 is to be displayed, and as depicted in FIG. 10, the window 62 may be set to be more transparent when a large-sized window 62 is to be displayed. The operator can thereby recognize the entire projected image 8 even though a broad region is sometimes hidden under the window 62.

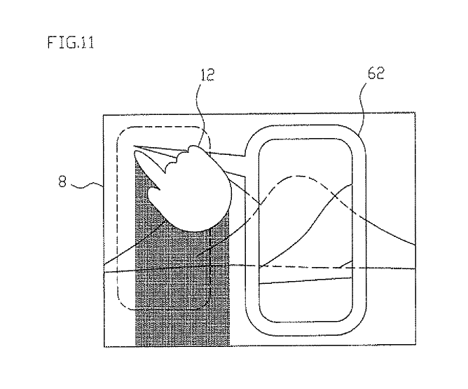

Further, in the projector 2 according to the above-described first embodiment, the window 62 is projected onto the region of the opposite side from the side in the projected image 8 where the hand 12 is found, but, for example, as depicted in FIG. 11, the window 62 may be projected on the side where the hand 12 is found when the position directly under the fingertip is located in the vicinity of the edge part of the projected image 8 and the side opposite the hand 12 lacks the space to project the window 62. The window 62 can thereby be projected accurately regardless of where on the projected image 8 is indicated by the hand 12.

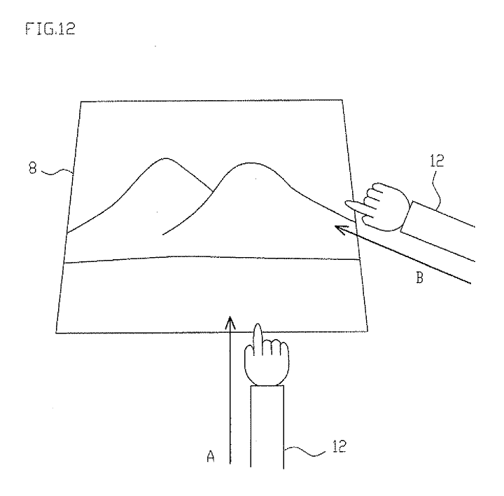

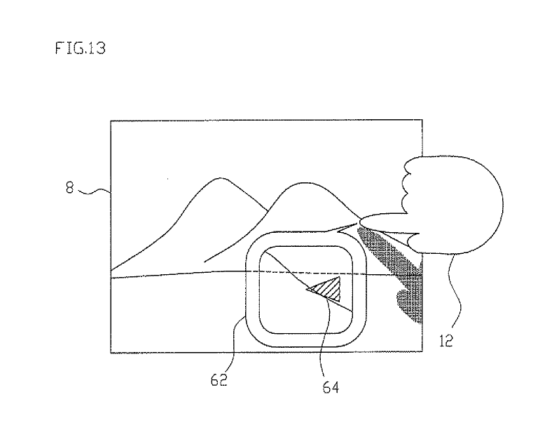

Further, the projector 2 according to the above-described embodiment 1, as depicted in FIG. 12, may be provided with a direction determination unit that determines whether the direction in which the hand 12 approaches belongs to the direction A along the projection direction or to the direction B intersecting the projection direction, such that the position at which the window 62 is projected may be modified in accordance with the direction of approach. For example, in a case in which the hand 12 approaches from the direction A along the projection direction, the window 62 is projected on the left-side region when the region of the hand 12 is found on the right side of the position directly under the fingertip (see FIG. 6). In a case in which the hand 12 approaches from the direction B intersecting the projection direction, the window 62 may be displayed in the lower-side region when the region of the hand 12 is found on the upper side of the position directly under the fingertip (see FIG. 13).

Further, in the projector 2 according to the above-described first embodiment, a determination is made in the hand recognition unit 36 as to whether the shape of the hand 12 is contained in the image data by detecting the region of the hand 12 and the position of the fingertip from the image data, but a determination may also be made as to whether the shape of an indication rod or the like is contained in the image data by detecting the region of the indication rod or the like and the tip position. The position directly under the tip of the indication member and the region shaded by the indication member can thereby be detected and the window 62 that displays the predetermined region containing the indication position can thereby be projected onto the projected image 8, even though a part of the projected image 8 is sometimes indicated by an indication member other than the hand 12.

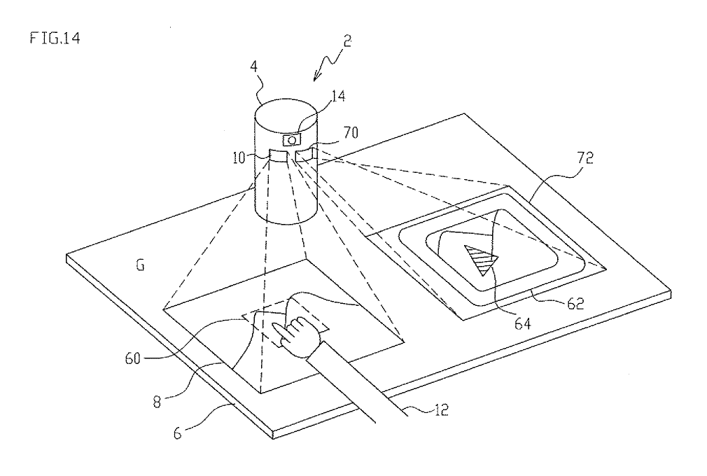

Further, in the projector 2 according to the above-described first embodiment, a description has been provided taking the example of a case in which the window 62 is superimposed and projected onto the projected image 8, but the window 62 may also be projected onto a region different from the projected image 8. For example, the projector 2 may be provided with an auxiliary projection unit that projects the window 62 onto another projection unit 34, such that, as depicted in FIG. 14, the window 62 is projected onto a region 72 adjacent to the projected image 8 via an auxiliary projection window 70 adjacent to the projection window 10. The image at the place that has been pointed to with the hand 12 can thereby be further clarified. Also, the position on the projected image 8 that has been pointed to with the hand 12 can be further clarified by the superposition and projection of the pointer 64 that shows the indication direction of the hand 12 inside the window 62. In such a case, the size of the window 62 may be made to correspond to the size of the region 60 in which image data is extracted.

In FIG. 14, the window 62 is projected onto a region 72 adjacent to the projected image 8, but the projected image 8 and the window 62 may also be projected side by side in a single region. For example, a single region may be partitioned into two, the projected image 8 being projected onto one side and the window 62 being projected onto the other side.

Further, in the projector 2 according to the above-described first embodiment, the projected image 8 is projected onto the mounting surface G of the desk 6, but the projected image may also be projected onto another level surface such as a wall or a floor. Projection may also be done onto a curved surface body such as a ball, or onto a moving object or the like.

Also, in the projector 2 according to the above-described first embodiment, the region containing the projected image 8 is photographed using the camera 24, but instead of the camera 24, a range image sensor may be used to perform ranging between the projector 2 and the indication member located in a region contained on the projected image 8 by scanning with a laser, so as to acquire range image data. The position directly under the fingertip and the region shaded by the hand 12 can thereby be easily detected, and the window 62 that displays the predetermined region containing the indication position can thereby be projected onto the projected image 8.

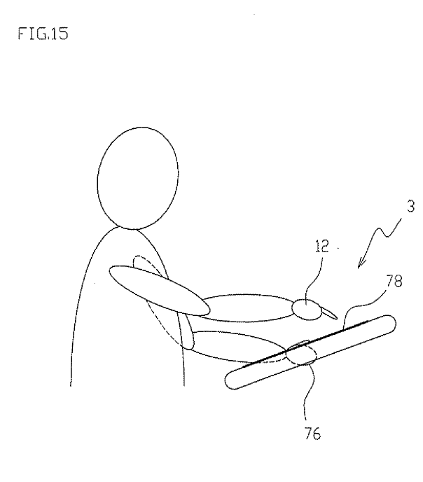

The following takes the example of a handheld tablet terminal to describe the image display device according to a second embodiment. FIG. 15 is a diagram depicting the operational state of the tablet terminal 3 according to the second embodiment. An operator holds up the tablet terminal 3 with a holding hand 76, and operates the tablet terminal 3 by touching the surface of a display unit 78 with the hand 12 that is not the holding hand 76.

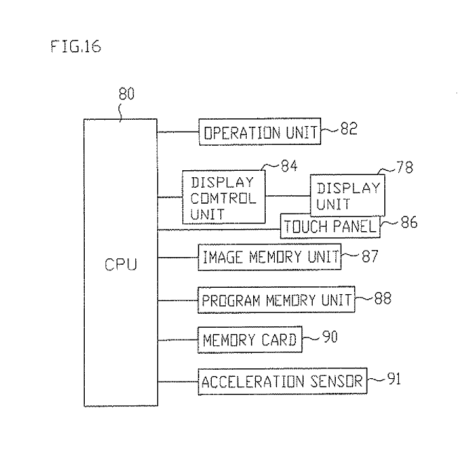

FIG. 16 is a block diagram depicting the system configuration of the tablet terminal 3 according to the second embodiment. The tablet terminal 3 is provided with a CPU 80, the CPU 80 being connected to an operation unit 82 provided with a power switch and the like (not shown); a display control unit 84 that controls the display of the display unit 78 that displays an image that is based on image data; a touch panel 86 that detects the position of a finger brought into contact with the display unit 78; an image memory unit 87 that temporarily stores image data of a predetermined region with respect to the position that has been touched; a program memory unit 88 that houses a program for setting and controlling related to the display and the like of the display unit 78; a memory card 90 that stores image data of an image to be displayed on the display unit 78; and an acceleration sensor 91 that measures the inclination angle of the tablet terminal 3 by detecting gravitational acceleration.

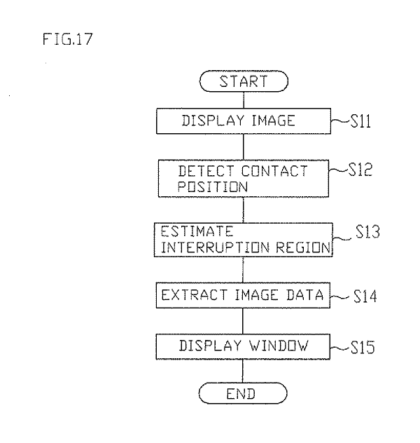

The following is a description of the process in the tablet terminal 3 according to the second embodiment, with reference to the flowchart depicted in FIG. 17. First, the tablet terminal 3 is held by the holding hand 76 of the operator (see FIG. 15), and when the power is switched on, the CPU 80 measures the inclination angle of the tablet terminal 3 using the acceleration sensor 91 and recognizes whether the tablet terminal 3 is oriented horizontally or vertically based on the inclination angle. Therefore, as depicted in FIG. 15, the CPU 80 recognizes that the tablet terminal 3 is oriented vertically when the operator holds the tablet terminal 3 so as to be able to view the display unit 78 vertically.

Next, the CPU 80 reads out the image data of an initial screen to be displayed on the display unit 78 from the memory card 90, and displays onto the display unit 78 an image that is based on the image data (step S11). Next, when the operator brings the hand 12 into contact with the display unit 78, the CPU 80 uses the touch panel 86 to detect the position at which the finger of the hand 12 has been brought into contact with the display unit 78 (hereinafter referred to as the contact position) (step S12).

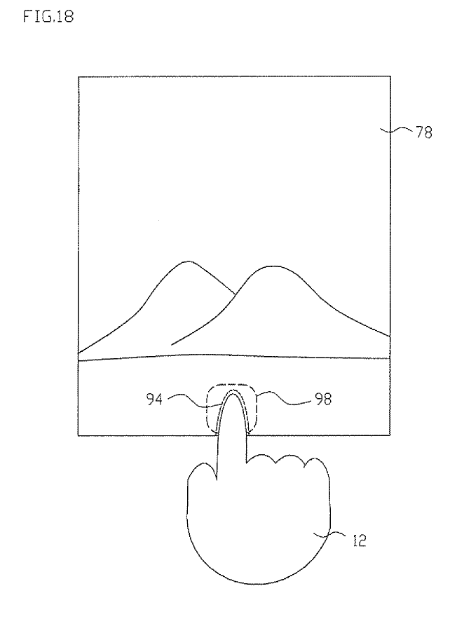

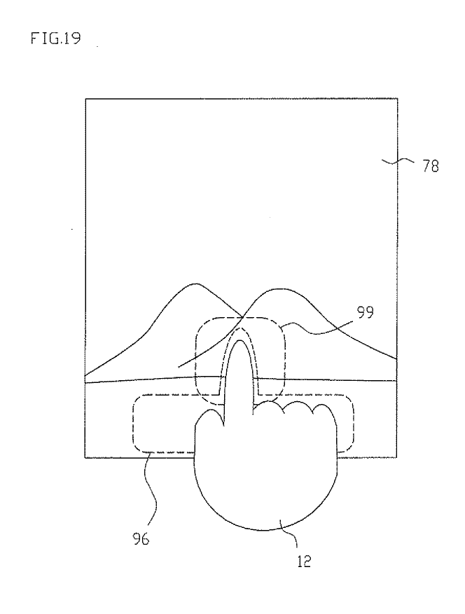

Next, the CPU 80 estimates an interruption region based on the contact position (step S13). Herein, the CPU 80 estimates that the area of the interruption region is smaller when the contact position is lower on the display unit 78, and estimates that the area of the interruption region is larger when the contact position is higher on the display unit 78. For example, as depicted in FIG. 18, the interruption region is estimated to be the narrow region 94 around the contact position when the position that has been touched is near the edge part on the lower side of the display unit 78. Further, as depicted in FIG. 19, the interruption region is estimated to be the broad region 96 down from the contact position when the position that has been touched is near the center of the display unit 78.

Herein, the region of the display unit 78 that is interrupted by the left hand is different from the region of the display unit 78 that is interrupted by the right hand, even when the contact position is the same, and therefore the CPU 80 estimates the interruption region by including the region that is interrupted by the hand on the side on which the display unit 78 has not been touched. For example, as depicted in FIG. 19, when the operator touches the display unit 78 with the right hand, the interruption region is estimated to include the region that would be interrupted when touched at the same position with the left hand. Similarly, when the operator touches the display unit 78 with the left hand, the interruption region is estimated to include the region that would be interrupted when touched at the same position with the right hand.

Next, the CPU 80 extracts image data for a predetermined region with respect to the contact position from the image data of the image that has been displayed on the display unit 78, and stores the extracted image data in the image memory unit 87 (step S14). Herein, the area of the predetermined region is determined in accordance with the area of the interruption region. For this reason, the CPU 80, as depicted in FIG. 18, extracts image data for a narrow-range region 98 when the area of the interruption region is small, and, as depicted in FIG. 19, extracts image data for a broad-range region 99 when the area of the interruption region is large.

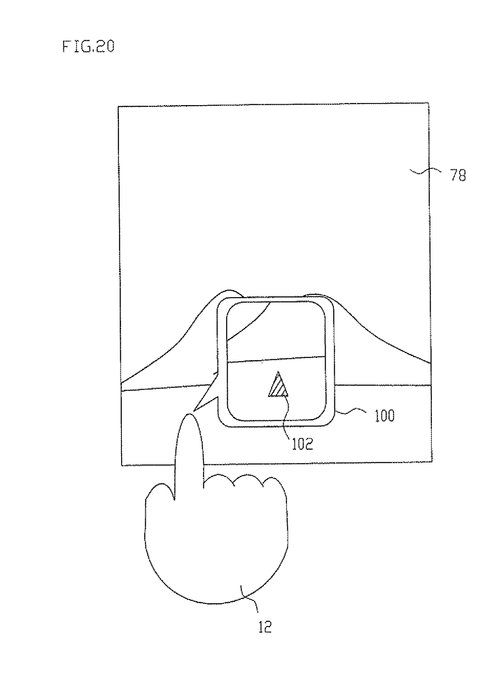

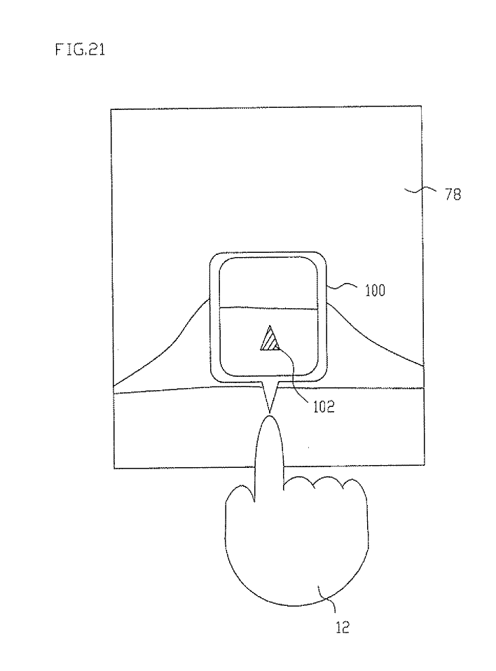

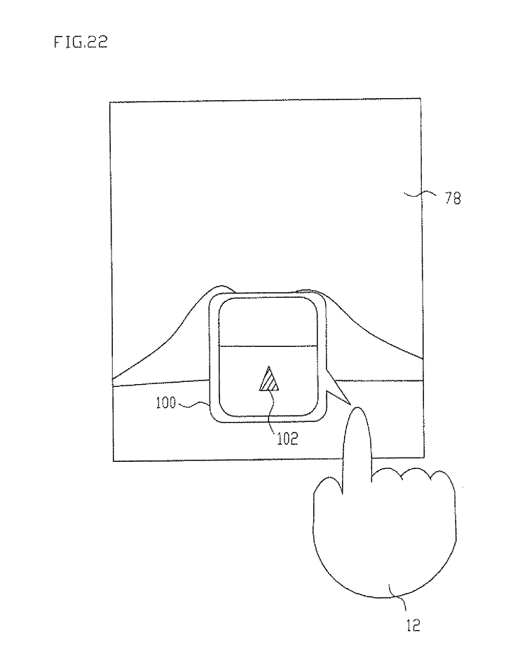

Next, the CPU 80 reads out the image data extracted from the image memory unit 87 and displays a window that displays an image that is based on the extracted image data, onto a region of the display unit 78 that is not interrupted by the hand 12 (hereinafter referred to as the non-interruption region) (step S15). For example, as depicted in FIG. 20, the window 100 is displayed on the non-interruption region of the upper-right side of the contact position when the position that has been touched is near the edge part on the lower-left side of the display unit 78. As depicted in FIG. 21, the window 100 is displayed on the non-interruption region of the upper side of the contact position when the position that has been touched is near the edge part down from the center of the display unit 78. As depicted in FIG. 22, the window 100 is displayed on the non-interruption region of the upper-left side of the contact position when the position that has been touched is near the edge part of the lower-right side of the display unit 78.

Herein, the size of the window 100 is determined in accordance with the size of the region in which image data is extracted. For this reason, a small-sized window 100 is displayed when the region in which image data is extracted is narrow, and a large-sized window 100 is displayed when the region in which image data is extracted is broad. Note that because the operator typically touches the display unit 78 while orienting the finger toward the upper side, the CPU 80, as depicted in FIGS. 20 to 22, displays and overlays the pointer 102 that indicates the contact position into the window 100, taking the upper side as the indication direction.

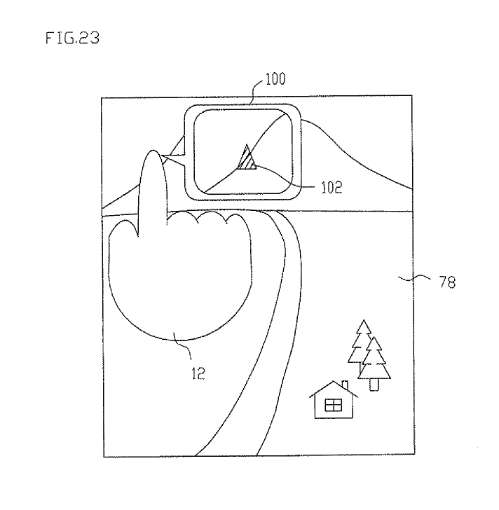

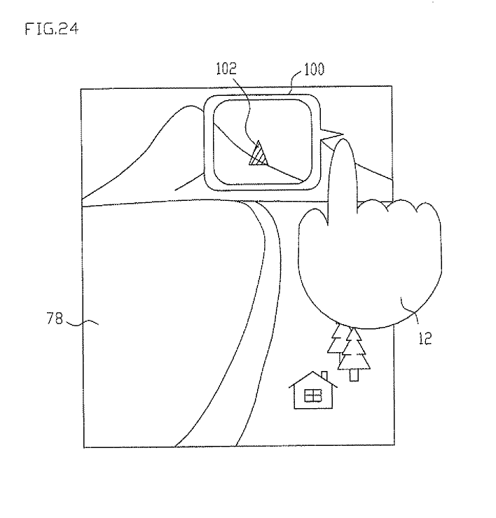

Note that the CPU 80 displays the window 100 in a non-interruption region of either the right side or the left side of the hand 12 when the position that is touched is near the edge part of the upper side of the display unit 78 and the upper side of the contact position lacks the space for displaying the window 100. For example, as depicted in FIG. 23, the window 100 is displayed in the non-interruption region of the right side of the contact position when the position that is touched is near the edge part of the upper-left side of the display unit 78. Further, as depicted in FIG. 24, the window 100 is displayed in the non-interruption region of the left side of the contact position when the position that is touched is near the edge part of the upper-right side of the display unit 78. Note that because the operator typically touches the display unit 78 while orienting the finger toward the upper side, the CPU 80, as depicted in FIGS. 23 and 24, displays and overlays the pointer 102 that indicates the contact position inside the window 100, taking the upper side as the indication direction.

According to the terminal tablet 3 based on this second embodiment, the image at a place that has been touched to with a fingertip can be clarified by displaying and overlaying the window 100 that displays the image contained in a predetermined region with respect to the contact position, onto an image that has been displayed on the display unit 78. Further, the position on the image that has been pointed to with the hand 12 can be further clarified by displaying and overlaying the pointer 102 that shows the indication direction of the hand 12 into the window 100.

The following takes the example of a handheld tablet terminal to describe the image display device according to a third embodiment. The tablet terminal according to this third embodiment uses a high-sensitivity electrostatic capacitance touch panel for the touch panel 86 of the tablet terminal 3 according to the second embodiment. Accordingly, a detailed description of those parts similar to the configuration of the second embodiment being omitted, a description is provided only for the points of difference. Further, the description is provided using the same reference numerals for the same parts of the configuration as in the second embodiment.

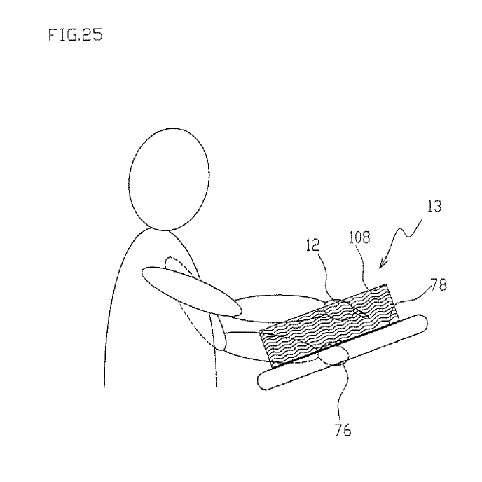

FIG. 25 is a diagram depicting the operational state of the tablet terminal 13 according to the third embodiment. As depicted in FIG. 25, an operator holds up the tablet terminal 13 with a holding hand 76, and when the hand 12 that is not the holding hand 76 is inserted into the detection region 108, the hand 12 is detected by the touch panel 86; the interruption region is estimated, and the window is displayed on the display unit 78. The operator operates the tablet terminal 3 by touching the display unit 78 with the hand 12, in a state in which the window has been displayed on the display unit 78.

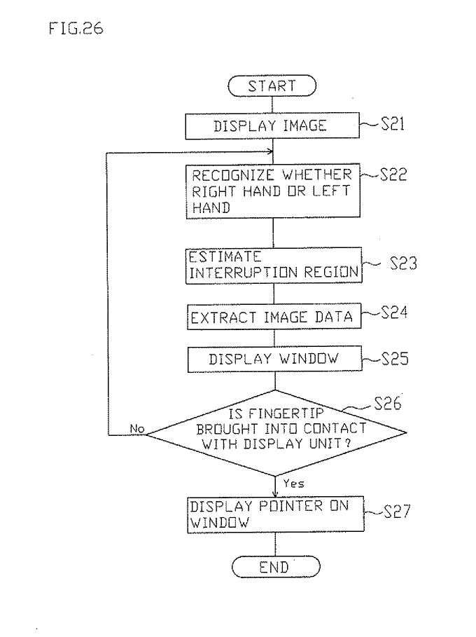

The following is a description of the process in the tablet terminal 13 according to the third embodiment, with reference to the flowchart depicted in FIG. 26. First, the tablet terminal 13 is held by the holding hand 76 of the operator (see FIG. 25), and when the power is switched on, the CPU 80 measures the inclination angle of the tablet terminal 13 using the acceleration sensor 91 and recognizes whether the tablet terminal 13 is oriented horizontally or vertically based on the inclination angle. Therefore, as depicted in FIG. 25, the CPU 80 recognizes that the tablet terminal 3 is oriented vertically when the operator holds the tablet terminal 13 so as to be able to view the display unit 78 vertically.

Next, the image data of an initial screen to be displayed on the display unit 78 is read out from the memory card 90, and an image that is based on the image data is displayed onto the display unit 78 (step S21). Next, when the operator brings the hand 12 to the display unit 78 and inserts the hand 12 into the detection region 108 (see FIG. 25), the CPU 80 uses the touch panel 86 to detect the position and shape of the hand 12, and recognizes whether the hand 12 touching the display unit 78 is the right hand or the left hand, on the basis of the position and shape of the hand 12 (step S22).

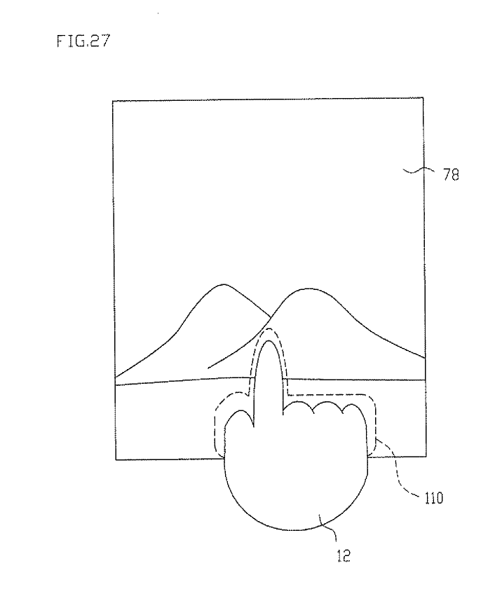

Next, the CPU 80 estimates the interruption region on the basis of the position and the shape of the right hand or left hand (step S23). For example, as depicted in FIG. 27, when the operator inserts the right hand into the detection region 108, the interruption region is estimated to be the region 110 of the display unit 78 interrupted by the right hand. Similarly, when the left hand has been inserted into the detection region 108, the interruption region is estimated to be the region of the display unit 78 interrupted by the left hand. Further, the CPU 80 estimates the position of the display unit 7 directly under the fingertip on the basis of the position and shape of the right hand or left hand.

Next, the CPU 80 extracts image data on a predetermined region with respect to the position directly underneath the fingertip, from the image data of the image displayed on the display unit 78; the extracted image data is then stored in the image memory unit 87 (step S24). Herein, the area of the predetermined region is determined in accordance with the area of the interruption region. Next, the CPU 80 reads out the image data extracted from the image memory unit 87 and, as depicted in FIGS. 20 to 24, displays, on the non-interruption region of the display unit 78, a window that displays an image that is based on the extracted image data (step S25). Herein, the size of the window is determined in accordance with the size of the region in which image data is extracted. Note that because the touch panel 86 detects the position and shape of the hand 12 sequentially, when the position of the hand 12 moves within the detection region 108, the display region of the window also moves along with the position of the hand 12.

Next, the CPU 80 uses the touch panel 86 to determine whether or not the finger of the hand 12 has been brought into contact with the display unit 78 (step S26). The CPU 80 repeats the process of steps S22 to 526 when the finger of the hand 12 has not been brought into contact with the display unit 78 (step S26: No). On the other hand, when the finger of the hand 12 has been brought into contact with the display unit 78 (step S26: Yes), the CPU 80 displays and overlays into the window a pointer that indicates the contact position, taking the upper side as the indication direction, as depicted in FIGS. 20 to 24 (step S27).

According to the tablet terminal 13 based on this third embodiment, the use of the high-sensitivity electrostatic capacitance touch panel 86 enables estimation of the interruption region before the operator touches the display unit 78, such that a window that displays an image contained in the predetermined region with respect to the position directly under the fingertip can be displayed and overlaid onto the image displayed on the display unit 78.

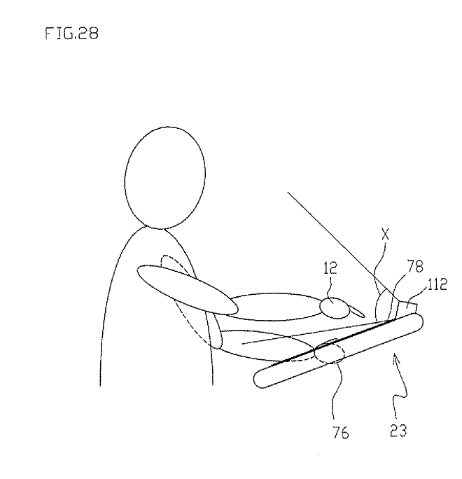

The following takes the example of a handheld tablet terminal to describe the image display device according to a fourth embodiment. As depicted in FIG. 28, the tablet terminal 23 according to the fourth embodiment is the tablet terminal 13 according to the second embodiment provided with an additional camera 112 to the frame portion on the top thereof, the camera 112 being used to photograph the hand 12 of an operator who has decided to touch the display unit 78. Accordingly, a detailed description of those parts similar to the configuration of the second embodiment being omitted, a description is provided only for the points of difference. Further, the description is provided using the same reference numerals for the same parts of the configuration as in the second embodiment.

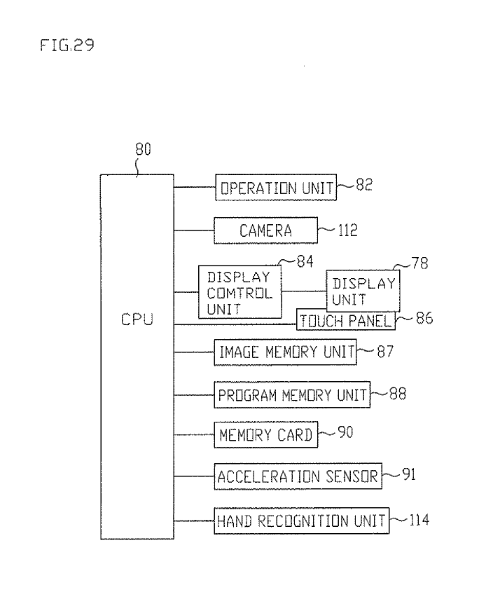

FIG. 29 is a block diagram depicting the system configuration of the tablet terminal 23 according to the fourth embodiment. The tablet terminal is provided with a CPU 80, the CPU 80 being connected to an operation unit 82; a camera 112 having an imaging sensor constituted of a CCD or the like that photographs a subject; a display control unit 84 that controls the display of the display unit 78; a touch panel 86; an image memory unit 87; a program memory unit 88; a memory card 90; an acceleration sensor 91; and a hand recognition unit 114 that determines whether or not a photographed image contains the shape of the hand 12.

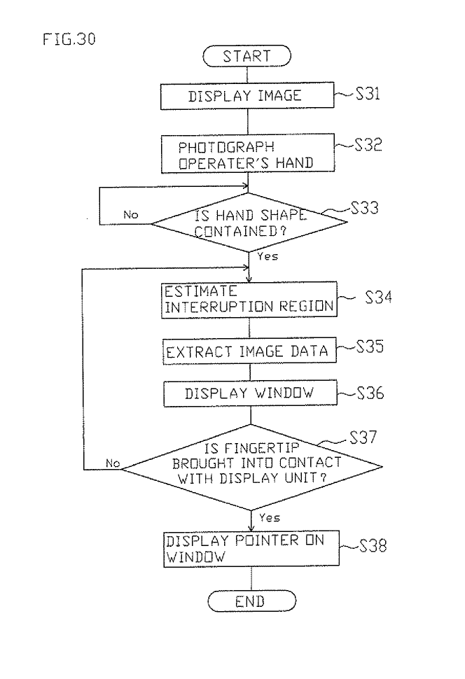

The following is description of the process in the tablet terminal 23 according to the fourth embodiment, with reference to the flowchart depicted in FIG. 30. First, the tablet terminal 23 is held by the holding hand 76 of the operator (see FIG. 28), and when the power is switched on, the CPU 80 measures the inclination angle of the tablet terminal 23 using the acceleration sensor 91 and recognizes whether the tablet terminal 23 is oriented horizontally or vertically based on the inclination angle. Therefore, as depicted in FIG. 28, the CPU 80 recognizes that the tablet terminal 3 is oriented vertically when the operator holds the tablet terminal 23 so as to be able to view the display unit 78 vertically.

Next, the CPU 80 reads out the image data of an initial screen to be displayed on the display unit 78 from the memory card 90, and displays onto the display unit 78 an image that is based on the image data (step S31). Next, the CPU 80 uses the camera 112 to begin photographing the hand 12 of an operator who has decided to touch the display unit 78, as depicted in FIG. 28 (step S32). Herein, the camera 112 photographs on the range X depicted in FIG. 28. Also, the photography is performed using video photography, or still image photography at fixed time intervals; image data of the image photographed by the camera 112 is stored in the image memory unit 87.

Next, the CPU 80 reads the image data from the image memory unit 87, and uses the hand recognition unit 114 to determine whether or not the image data contains the shape of the hand 12 (step S33). Herein, the determination of whether or not the shape of the hand 12 is contained is performed to detect the position of the hand 12 and of the fingertip of the hand 12 from the image data by using pattern matching or the like.

The CPU 80 repeats the operation of step S33 when the image data does not contain the shape of the hand 12 (step S33: No). On the other hand, when the image data does contain the shape of the hand 12 (step S33: Yes), the CPU 80 estimates the interruption region from the position of the hand 12 contained in the image data (step S34). The position of the display unit 78 directly under the fingertip is also estimated.

Next, the CPU 80 extracts image data on a predetermined region with respect to the position directly under the fingertip, from the image data of the image displayed on the display unit 78; the extracted image data is then stored in the image memory unit 87 (step S35). Herein, the area of the predetermined region is determined in accordance with the area of the interruption region. Next, the CPU 80 reads out the image data extracted from the image memory unit 87 and, as depicted in FIGS. 20 to 24, displays, on the non-interruption region of the display unit 78, a window that displays an image that is based on the extracted image data (step S36). Herein, the size of the window is determined in accordance with the size of the region in which image data is extracted.

Note that the position directly under the fingertip is detected sequentially, because the camera 112 photographs using video photography or the like. Also, the window that displays the image of the predetermined region with respect to the position directly under the fingertip is displayed sequentially on the display unit 78. Therefore, when the position of the hand 12 moves within the display unit 78, the display region of the window also moves along with the position of the hand 12.

Next, the CPU 80 uses the touch panel 86 to determine whether or not the finger of the hand 12 has been brought into contact with the display unit 78 (step S37). The CPU 80 repeats the operation of steps S34 to S37 when the finger of the hand 12 has not been brought into contact with the display unit 78 (step S37: No). On the other hand, when the finger of the hand 12 has been brought into contact with the display unit 78 (step S37: Yes), the CPU 80 displays and overlays into the window a pointer that indicates the contact position, taking the upper side as the indication direction, as depicted in FIGS. 20 to 24 (step S38).

According to the tablet terminal 23 based on this fourth embodiment, the use of the camera 112 to photograph the hand 12 of the operator who has decided to touch the display unit 78 enables an accurate estimation of the interruption region from the position of the hand 12 contained in the image data of the photographed image.

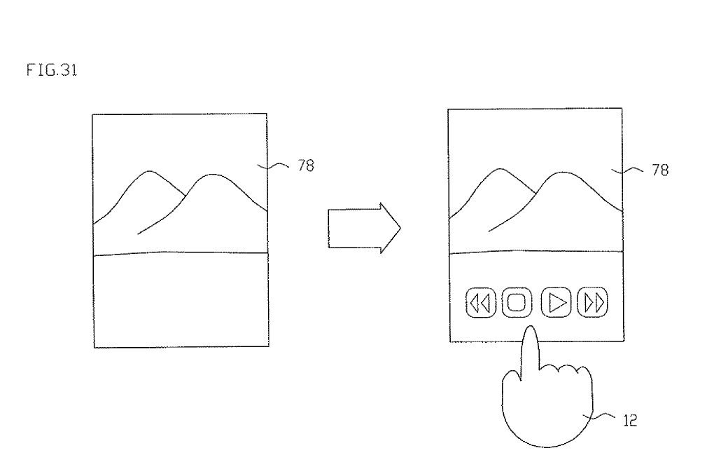

Also, because the camera 112 is used to photograph the hand 12 of the operator (see FIG. 28), the hand 12 of the operator can be recognized provided that the image data contains the shape of the hand 12, even when the hand 12 of the operator is separated from the display unit 78. It is therefore possible to add a function for carrying out a given operation when the tablet terminal 23 recognizes the hand 12 of the operator. For example, provided when the image depicted on the left side of FIG. 31 is displayed on the display unit 78, the hand 12 approaches the photography region of the camera 112, and the CPU 80 recognizes the hand 12 of the operator from the image data photographed by the camera 112. In such a case, as depicted in the drawing on the right side of FIG. 31, the CPU 80 may be made to display an operation button overlaid onto an image displayed on the display unit 78.

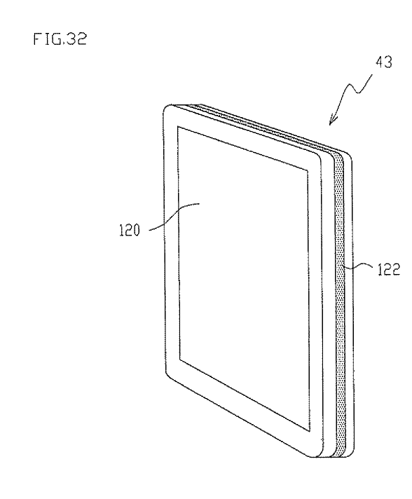

The following takes the example of a small handheld terminal (for example, a mobile phone, a smartphone, or the like; hereinafter referred to as a small terminal) to describe an image display device according to a fifth embodiment. FIG. 32 is a diagram depicting the small terminal 43 according to the fifth embodiment. As depicted in FIG. 32, the small terminal 43 is provided with a display unit 120 that can be operated using a touch panel on one surface of a plate-shaped casing, and is provided with a touch sensor 122 that detects the holding hand of an operator all around the side surfaces of the casing.

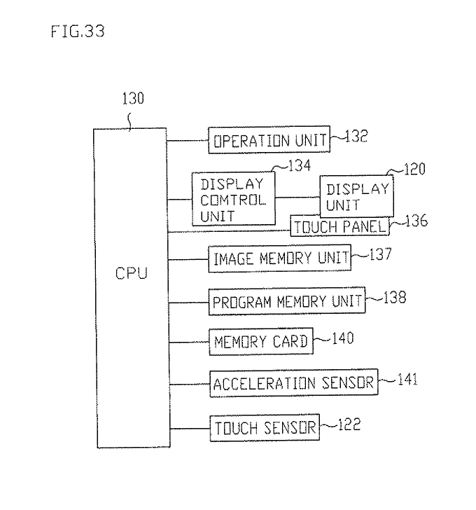

FIG. 33 is a block diagram depicting the system configuration of the small terminal 43 according to the fifth embodiment. The small terminal 43 is provided with a CPU 130, the CPU 130 being connected to an operation unit 132 provided with a power switch and the like (not shown); a display control unit 134 that controls the display of a display unit 120 that displays an image that is based on image data; a touch panel 136 that detects the position of a finger that has been brought into contact with the display unit 120; an image memory unit 137 that temporarily stores image data of a predetermined region with respect to the position that has been touched; a program memory unit 138 that houses a program for setting and controlling related to the display and the like of the display unit 120; a memory card 140 that stores image data of an image to be displayed on the display unit 120; an acceleration sensor 141 that measures the inclination angle of the small terminal 43 by detecting gravitational acceleration, and a touch sensor 122.

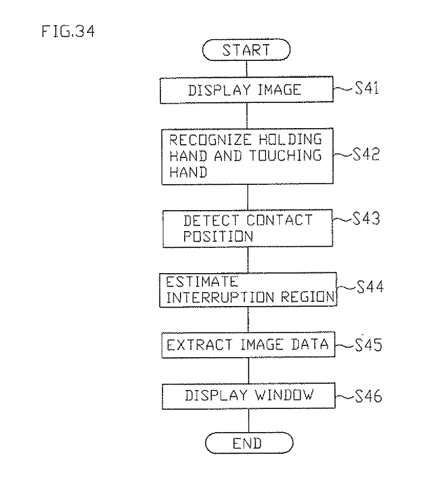

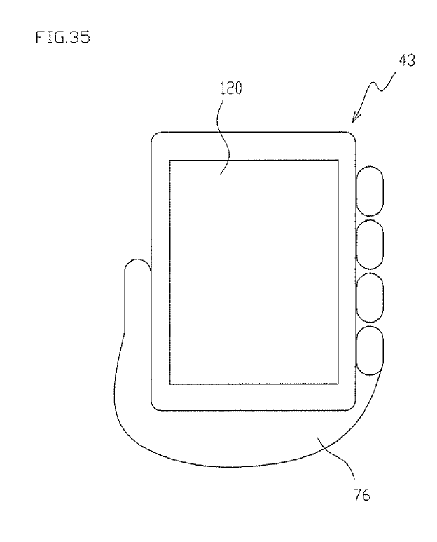

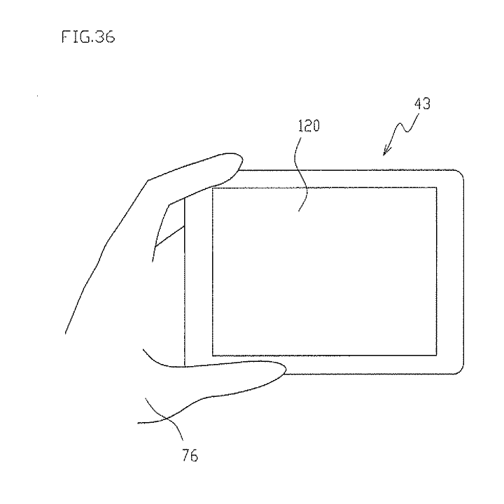

The following is a description of the process in the small terminal 43 according to the fifth embodiment, with reference to the flowchart depicted in FIG. 34. First, the small terminal 43 is held by the holding hand 76 of the operator, and when the power is switched on, the CPU 130 measures the inclination angle of the small terminal 43 using the acceleration sensor 141 and recognizes whether the small terminal 43 is oriented horizontally or vertically based on the inclination angle. For example, as depicted in FIG. 35, the CPU 130 recognizes that the small terminal 43 is vertical when the operator holds the small terminal 43 so as to be able to view the display unit 120 vertically, and, as depicted in FIG. 36, the CPU 130 recognizes that the small terminal 43 is oriented horizontally when the operator holds the small terminal 43 so as to be able to view the display unit 120 horizontally.

Next, the CPU 130 reads out the image data of an initial screen to be displayed on the display unit 120 from the memory card 140, and displays an image that is based on the image data on the display unit 120 (step S41).

Next, the CPU 130 detects the position and number of finger(s) brought into contact with the touch sensor 112, and recognizes the holding hand 76, as well as the hand 12 touching the display unit 120, on the basis of the position and number of detected finger(s) (step S42). For example, as depicted in FIG. 35, provided that the operator decides to hold the small terminal 43 in the left hand, oriented vertically. Then, the touch sensor 122 detects that one finger has been brought into contact with the left side surface of the small terminal 43 and that four fingers have been brought into contact with the right side surface. In this case, the CPU 130 recognizes the left hand as the holding hand 76, and recognizes the right hand, which is not the holding hand, as the hand 12 touching the display unit 120. Also, as depicted in FIG. 36, provided that the operator decides to hold the small terminal 43 in the left hand, oriented horizontally. Then, the touch sensor 122 detects that one finger has been brought into contact with the left sides of the top and bottom side surfaces, each, of the small terminal 43. In this case, the CPU 130 recognizes the left hand as the holding hand 76, and recognizes the right hand as the hand 12 touching the display unit 120.

Next, when the operator brings the finger 12 into contact with the display unit 120, the CPU 130 uses the touch panel 136 to detect the contact position of the finger on the display unit 120 (step S43). Next, the CPU 130 estimates the interruption region on the basis of the contact position and the information on the touching hand 12 recognized by the touch sensor 122 (step S44). For example, when the right hand has been recognized as the touching hand 12, the interruption region is estimated to be the region of the display unit 120 interrupted when the display unit 120 is touched with a fingertip of the right hand. Similarly, when the left hand is recognized as the touching hand 12, the interruption region is estimated to be the region of the display unit 120 that is interrupted when the display unit 120 is touched with a fingertip of the left hand. Herein, the CPU 130 estimates that the area of the interruption region is smaller when the contact position is lower on the display unit 120, and estimates that the area of the interruption region is larger when the contact position is higher on the display unit 120.

Next, the CPU 130 extracts image data for a predetermined region with respect to the contact position from the image data of the image that has been displayed on the display unit 120, and stores the extracted image data in the image memory unit 137 (step S45). Herein, the area of the predetermined region is determined in accordance with the area of the interruption region. For this reason, the CPU 130 extracts image data for a narrow-range region when the area of the interruption region is small (see FIG. 18), and extracts image data for a broad-range region when, the area of the interruption region is large (see FIG. 19).

Next, the CPU 130 reads out the image data extracted from the image memory unit 137, and, as depicted in FIGS. 20 to 22, displays in the non-interruption region of the display unit 120 a window that displays an image that is based on the extracted image data (step S46). Herein, the size of the window is determined in accordance with the size of the region in which image data is extracted. Note that because the operator typically touches the display unit 120 while orienting the finger toward the upper side, the CPU 130, as depicted in FIGS. 20 to 22, displays and overlays a pointer that indicates the contact position inside the window, taking the upper side as the indication direction.

According to the small terminal 43 based on this fifth embodiment, displaying and overlaying the window that displays an image contained in a predetermined region with respect to the contact position onto the image displayed on the display unit 120 enables a clarification of the image at the place that has been touched with the fingertip. Further, the position on the image, that has been pointed to with the hand 12 can be further clarified by displaying and overlaying the pointer that shows the indication direction of the hand 12 into the window. The interruption region can also be estimated with a high degree of accuracy, because it is possible to recognize whether the hand 12 that is touching the display unit 120 is the right hand or the left hand.

Note that in the small terminal 43 according to the above-described fifth embodiment, the position and number of finger(s), when the holding hand 76 and the hand 12 touching the display unit 120, are recognized are not limited to the example described in the fifth embodiment. For example, FIG. 35 illustrates an example of a case in which four fingers are brought into contact with the right side surface of the small terminal 43, but the number of contacted fingers may be two or three. Also, FIG. 36 illustrates an example of a case in which one finger is brought into contact with the left side of the top and bottom side surfaces, each, of the small terminal 43, but one finger may be brought into contact with the upper-left corner and lower-left corner, each, of the side surfaces of the small terminal 43, and also one finger may be brought into contact with the left side surface and the left side of the bottom side surface, each, in the small terminal 43.

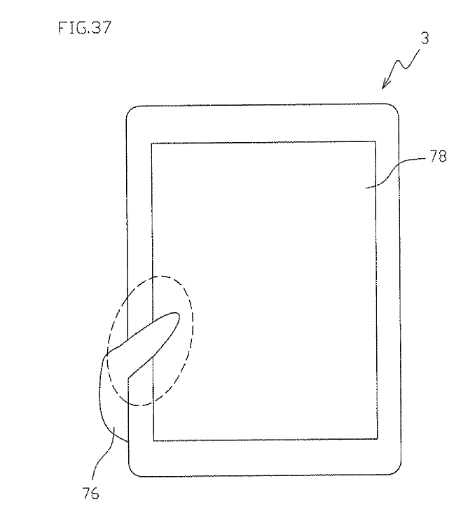

The tablet terminal 3 according to the above-described second embodiment may also be made to be able to recognize whether the hand 12 that is touching the display unit 78 is the right hand or the left hand. For example, when a finger is brought into contact with the display unit 78 for longer than a given period of time, the CPU 80 determines whether the position at which the finger is brought into contact (hereinafter referred to as the continuous contact position) is at the end of the right side or the end of the left side of the display unit 78. Also, as depicted in FIG. 37, when the continuous contact position is at the end of the left side of the display unit 78, the CPU 80 recognizes the left hand as the holding hand 76 and recognizes the right hand, which is not the holding hand 76, as the hand 12 that is touching the display unit 78. Similarly, when the continuous contact position is at the end of the right side of the display unit 78 (not shown), the CPU 80 recognizes the right hand as the holding hand 76, and recognizes the left hand, which is not the holding hand 76, as the hand 12 that is touching the display unit 78. The CPU 80 can thereby estimate the interruption region with a higher degree of accuracy, giving consideration to whether the band 12 that is touching is the right hand or the left hand.

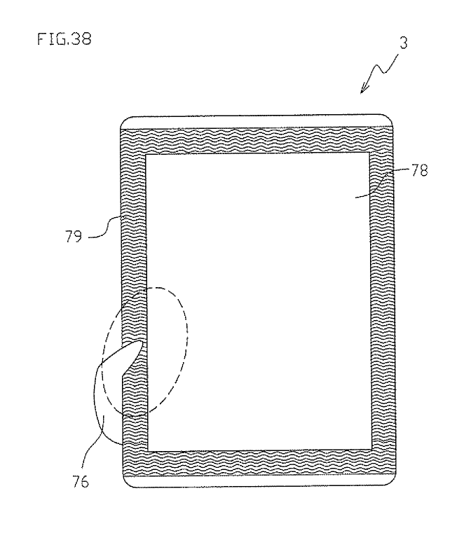

As depicted in FIG. 38, a touch sensor may also disposed on the frame portion 79 of the display unit 78, such that it can be determined whether the position of a finger that has been brought into contact with the frame portion 79 for longer than a given period of time is at the end of the right side or the end of the left side of the display unit 78. The CPU 80 can thereby recognize which of the holding hand 76 and the hand 12 touching the display unit 78 is the right hand and which is the left, even when the finger is not brought into contact with the display unit 78.

A touch sensor may further be disposed on the back surface of the tablet terminal 3. In such a case, when a finger of the operator is brought into contact with the back surface of the tablet terminal 3 for longer than a given period of time, the CPU 80 determines whether the position at which the finger has been brought into contact is on the backside of the right side end or the backside of the left side end of the display unit 78. Next, the CPU 80 recognizes which of the holding hand 76 and the hand 12 touching the display unit 78 is the right hand and which is the left hand, on the basis of the determined results.

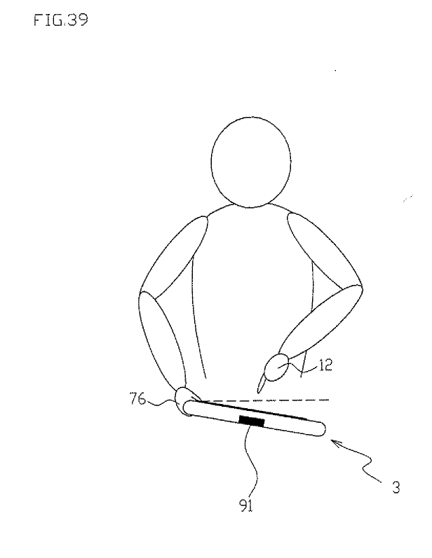

Further, the tablet terminal 3 according to the above-described second embodiment may be made to recognize the holding hand 76 and the hand 12 touching the display unit 78 on the basis of the inclination angle of the tablet terminal 3. For example, as depicted in FIG. 39, provided that the operator holding the tablet terminal 3 with the right hand, the acceleration sensor 91 decides to detect that the tablet terminal 3 is inclined downward to the left. In this case, the CPU 80 recognizes the right hand as the holding hand 76, and recognizes the left hand as the hand 12 that is touching the display unit 78. Similarly, provided that the operator holding the tablet terminal 3 with the left hand, the acceleration sensor 91 decides to detect that the tablet terminal 3 is inclined downward to the right (not shown). In this case, the CPU 80 may recognize the left hand as the holding hand 76, and recognize the right hand as the hand 12 that is touching the display unit 78.

The tablet terminal 3 according to the above-described second embodiment may also be made to be able to detect a plurality of contact positions using the touch panel 86. In a case in which a plurality of fingers is brought into contact with the display unit 78, an interruption region that includes a plurality of contact positions may be estimated. The image at the place that has been touched with the fingertips can thereby be clarified even when a plurality of fingers are used to operate the touch panel 86.

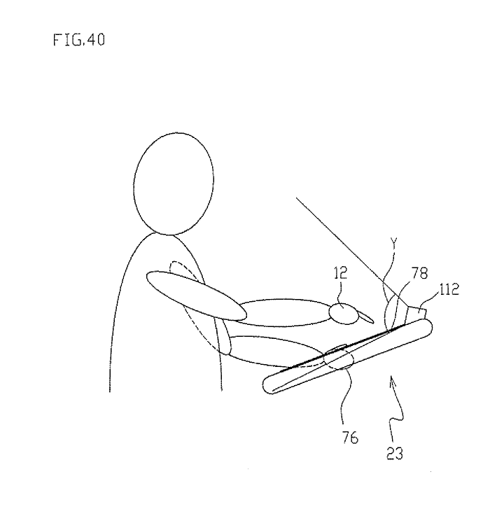

Further, in the tablet terminal 23 according to the above-described fourth embodiment, as depicted in FIG. 40, the photography range Y of the camera 112 may be made to include the surface of the tablet terminal 23. A determination may further be made from the image data of the image photographed by the camera 112 as to whether a fingertip has been brought into contact with the surface of the tablet terminal 23. The contact position can thereby be detected even when the tablet terminal 23 is not provided with a touch panel.

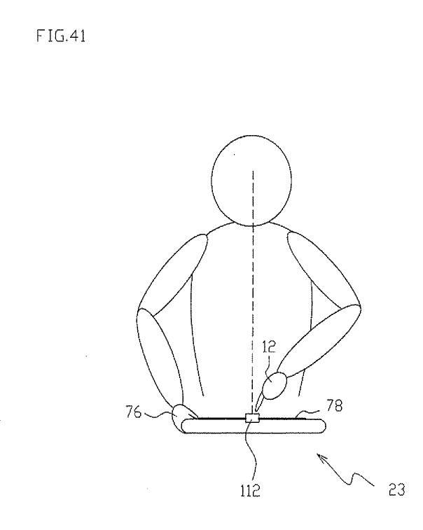

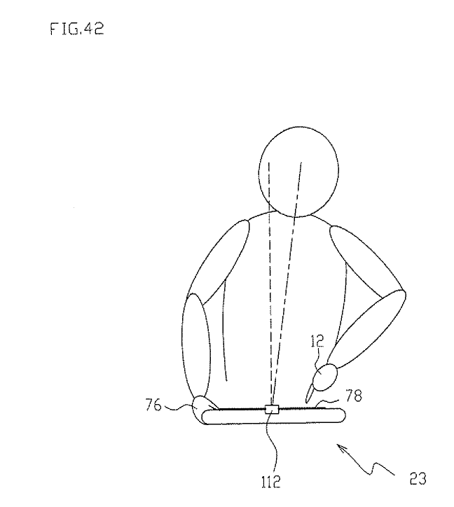

The tablet terminal 23 according to the above-described fourth embodiment may further be made to detect the position of the eyes of the operator from the image data of the image photographed by the camera 112, so as to estimate the interruption region in consideration of the perspective of the operator. For example, as depicted in FIG. 41, when the operator operates the tablet terminal 23 while looking from directly above, the CPU 80 estimates the interruption region to be the region of the display unit 78 located directly underneath the hand 12. As depicted in FIG. 42, when the operator operates the tablet terminal 23 while looking it from an inclined direction, the face turned to the left, then the CPU 80 may be made to estimate the interruption region to be a region of the display unit 78 located to the right from directly under the hand 12. In this case, the position of the window to be displayed on the display unit 78 is also displayed to the right of the position of the window from when operating the tablet terminal 23 while looking it from directly above (see FIG. 41). The interruption region can thereby be accurately estimated so as to match the perspective of the operator, such that the window is displayed so as to be more easily viewed by the operator.

The terminals according to the above-described second to fifth embodiments may be further provided with a personal history memory unit that stores whether the hand 12 that touched the display unit 78 is the right hand or the left hand, as personal history information, such that the hand 12 touching the display unit 78 is set as the right hand or the left hand, on the basis of the personal history information. For example, when personal history information that the right hand is the hand 12 that touched the display unit 78 repeats a given number of times, the CPU 80 sets the right hand as the hand 12 that touches the display unit 78. The CPU 80 can thereby rapidly and accurately estimate the interruption region on the basis of the information that has been set. Note that the hand 12 that touches the display unit 78 may also be set as the right hand or the left hand by the operation of the operator. Also, when the power is switched off, the personal history information may be deleted.

Further, in the terminals according to the above-described second to fifth embodiments, the window may be made to be transparent. In this case, the transparency may be altered are conjunction with the size of the window. Thereby, even when the window is displayed and overlaid onto the image displayed on the display unit, the operator can recognize the image in the portion hidden underneath the window. Also, the window may be set to be less transparent when a small-sized window is to be displayed, and the window may be set to be more transparent when a large-sized window is to be displayed. The operator can thereby recognize the entire image displayed on the display unit even when a broad region is hidden underneath the window.

The terminals according to the above-described second to fifth embodiments has been described taking the example of when the touch panel is operated using the hand 12, but an indication rod or the like may also be used to operate the touch panel. The interruption region may also be estimated to be the region on the display unit that is interrupted by the indication rod or the like.

Further, the terminals according to the above-described second to fifth embodiments have been described taking the example of a case in which a window is displayed and overlaid onto an image displayed on the display unit, but the display region in the display unit may also be partitioned into two, such that an image is displayed in one display region and the window is displayed in the other display region. The image at the place that has been pointed to with the hand 12 can thereby be further clarified. Further, the position on the display unit that has been pointed to with the hand 12 can be further clarified by displaying and overlaying the pointer that shows the indication direction of the hand 12 into the window. In such a case, the size of the window may be made to correspond to the size of the region in which image data is extracted.

The above-described embodiments have been recited in order to facilitate understanding of the present invention, and are not recited in order to limit the present invention. Accordingly, in effect, each element disclosed in the above-described embodiments also includes all design changes and equivalents falling within the technical scope of the present invention.

1. An image display device, comprising:
an image display unit that displays an image that is based on image data;
a detection unit that detects a position corresponding to the tip of an indication member that indicates a part of the image displayed by the image display unit;
extraction unit that extracts image data on a predetermined region comprising the position corresponding to the tip from the image data; and
a control unit that controls such that a window that displays an image that is based on the extracted image data extracted by the extraction unit is displayed on the image display unit.

2. The image display device according to claim 1, wherein
the image display unit is provided with a projection unit that projects an image that is based on image data onto a projection surface, and
the control unit controls such that the projection unit projects a window that displays an image that is based on the extracted image data.

3. The image display device according to claim 2, wherein the control unit controls such that the window is projected onto a region that is different from the image that has been projected by the projection unit.

4. The image display device according to claim 2, wherein the control unit controls such that the window is superimposed and projected onto the image that has been projected by the projection unit.

5. The image display device according to claim 3, wherein the control unit determines an area for displaying the window on the basis of an area shaded by the indication member on the image that has been projected by the projection unit.

6. The image display device according to claim 4, wherein the control unit controls such that the window is superimposed and projected onto a region that is not shaded by the indication member on the image that has been projected by the projection unit.

7. The image display device according to claim 6, wherein the control unit controls such that the window is projected and superimposed onto a region on the opposite side of the region in which the indication member is found, with respect to the position corresponding to the tip.

8. The image display device according to claim 4, wherein
the window has transparency, and
the control unit alters the transparency of the window on the bases of the area of the window.

9. The image display device according to claim 3, comprising:
a pointer image memory unit that stores image data of a pointer image that shows the indication direction; and
a direction detection unit that detects the indication direction of the indication member, wherein
the control unit controls such that the pointer image is superimposed and projected onto a position corresponding to a position indicated on the window on the basis of the indication direction when the image on the projection surface is indicated by the indication member.

10. The image display device according to claim 2, wherein the projection surface is a mounting surface for the image display device.

11. The image display device according to claim 1, wherein
the image display unit is provided with a display surface on which to display an image that is based on image data, and
the control unit controls such that the window that displays the image that is based on extracted image data is displayed on the display surface.

12. The image display device according to claim 11, comprising an estimation unit that estimates an interruption region in which the image displayed by the image display unit is interrupted by the indication member, on the basis of the position detected by the detection unit, wherein
the control unit controls such that the window is displayed in a region other than the interruption region estimated by the estimation unit.

13. The image display device according to claim 11, wherein the control unit controls such that the window is displayed at a size that is determined on the basis of the area of the interruption region estimated by the estimation unit.

14. The image display device according to claim 12, wherein
the detection unit is provided with a touch panel that detects the position of the tip of the indication member that has been brought into contact with the display surface, and
the estimation unit estimates the interruption region on the basis of the position of the tip of the indication member that is detected by the touch panel.

15. The image display device according to claim 1, wherein the image display device is a mobile information terminal.

16. The image display device according to claim 15, comprising a holding hand detection unit that detects the holding hand retaining the image display device, wherein
the estimation unit estimates the interruption region in consideration of the holding hand detected by the holding hand detection unit.

17. The image display device according to claim 16, comprising a determination unit that determines the position at which and time during which a hand of an operator is continuously brought into contact with the display surface, wherein
the holding hand detection unit detects the holding hand on the basis of the determined results by the determination unit.

18. The image display device according to claim 16, comprising a measurement unit that measures the inclination angle of the image display device, wherein
the holding hand detection unit detects the holding hand on the basis of the inclination angle measured by the measurement unit.

19. The image display device according to claim 16, comprising a contact detection unit that detects the position and number of fingers of an operator that have been brought into contact with a side surface of the image display device, wherein
the holding hand detection unit detects the holding hand on the basis of the position and number of the fingers of the operator that have been brought into contact with a side surface of the image display device.

20. The image display device according to claim 14, wherein the touch panel is an electrostatic capacitance touch panel capable of recognizing an indication member before the tip of the indication member is brought into contact with the image display unit.

21. The image display device according to claim 12, comprising a photography unit that photographs the indication member, wherein
the estimation unit estimates the interruption region on the basis of the position of the indication member contained in the image data photographed by the photography unit.

22. The image display device according to claim 21, wherein
the photography unit photographs the eyes of the operator, and
the estimation unit estimates the interruption region in consideration of the position of the eyes of the operator contained in the image data photographed by the photography unit.

23. The image display device according to claim 11, wherein
the window has transparency, and
the control unit alters the transparency of the window on the bases of the area of the window.

24. The image display device according to claim 1, wherein the detection unit detects a position corresponding to the tip of the hand of the operator.
